(19) United States
(12) Patent Application Publication
(10) Pub. No.: US 2013/0170100 A1
(43) Pub. Date: Jul. 4, 2013

(54) ELECTRODE, METHOD FOR PREPARING THE SAME, AND ELECTROCHEMICAL CAPACITOR INCLUDING THE SAME

(71) Applicant: c/o Samsung Electro-Mechanics Co., Ltd., Gyeonggi-do (KR)

(72) Inventors: Sang Kyun LEE, Suwon-si (KR); Bae Kyun KIM, Seongnam-si (KR); Hyun Chul JUNG, Yongin-si (KR)

(73) Assignee: c/o SAMSUNG ELECTRO-MECHANICS CO., LTD., Gyeonggi-do (KR)

(21) Appl. No.: 13/732,121

(22) Filed: Dec. 31, 2012

(30) Foreign Application Priority Data
Dec. 29, 2011 (KR) 10-2011-0146363

(51) Int. Cl. H01G 11/24

(52) U.S. Cl. CPC H01G 11/24
USPC 361/502; 427/80

(57) ABSTRACT

Disclosed herein are an electrode including a plurality of electrode active material layers formed above an electrode current collector, each of the electrode active material layers including different structures of binders; a method for manufacturing the same; and an electrochemical capacitor.
According to the present invention, physical bonding strength of the electrode can be significantly improved, and thus, long-term reliability of the electrochemical capacitor can be improved, by developing an electrode in which the binder composition of a bonding portion of an electrode and an electrode current collector and the binder composition between the electrode active material layers are differentiated from one another, in order to develop low-resistance EDLC products.

### CROSS REFERENCE(S) TO RELATED APPLICATIONS

This application claims the benefit under 35 U.S.C. Section 119 of Korean Patent Application Serial No. 10-2011-0146363, entitled “Electrode, Method for Preparing the Same, and Electrochemical Capacitor Including the Same” filed on Dec. 29, 2011, which is hereby incorporated by reference in its entirety into this application.

### BACKGROUND OF THE INVENTION

1. Technical Field

The present invention relates to an electrode including an active material layer having different binder compositions, a method for preparing the same, and an electrochemical capacitor including the same.

2. Description of the Related Art

Recently, an electric double layer capacitor (EDLC) has been successfully developed in relation to environmental problems because it has excellent input and output characteristics and high cycle reliability, as compared with a secondary battery, such as a lithium ion secondary battery. For example, the electric double layer capacitor is promising as a power-storage device, which stores main power and subsidiary power of electric vehicles or renewable energy such as solar light, wind power, or the like.

In addition, the electric double layer capacitor is expected to be also utilized as a device capable of outputting large current for a short time in an uninterruptible power supply device which is increasingly demanded by information technology (IT).

In addition, the electric double layer capacitor (EDLC) indicates an energy storage device having significantly more capacitance as compared with a condenser or an electrolytic liquid capacitor, and is called a super-capacitor or an ultra-capacitor. The EDLC is a power source which stores a lot of energy and then releases high energy for several tens of seconds or several minutes, and a useful component which can account for a performance characteristic area where the existing condenser and secondary battery cannot occupy.

This electric double layer capacitor has a structure where a separator inserted between a pair of or a plurality of polarizable electrodes (cathode•anode) mainly consisting of a carbon material and facing each other is immersed in an electrolytic liquid. Here, charges are stored on an electric double layer formed at an interface between the polarizable electrode and the electrolytic liquid.

FIG. 1 shows an operating principle and a basic structure of an electric double layer capacitor. Referring to this, current collectors 10, electrodes 20, an electrolytic liquid 30, and a separator 40 are disposed from both sides of the electric double layer capacitor.

The electrode 20 consists of an active material made of a carbon material having a large effective specific surface area, such as an activated carbon powder, an activated carbon fiber, or the like, a conductive agent for imparting conductivity, and a binder for providing a binding force between respective components. In addition, the electrodes 20 include a cathode 21 and an anode 22 with a separator 40 therebetween.

In addition, as the electrolytic liquid 30, aqueous electrolytic liquid and non-aqueous (organic) electrolytic liquid are used.

The separator 40 is made by using polypropylene, Teflon, or the like, and serves to prevent a short circuit due to contact between the cathode 21 and the anode 22.

When voltage is applied to the EDLC at the time of charging, electrolytic ions 31a and 31b dissociated from surfaces of the cathode 21 and anode 22 are physically absorbed on the counter electrodes to store electricity. At the time of discharging, the ions of the cathode 21 and the anode 22 are desorbed from the electrodes, resulting in a neutralized state.

In general, an active material used as a main material of the electrochemical capacitor is advantageous in generation of electrons on an interface by using a wide specific surface area thereof. But, since the active material has relatively low conductivity, a nanometer-sized conductive agent is generally added so as to implement required characteristics. However, a desired low resistance characteristic cannot be realized by general processes even though only the added amount of the conductive agent is increased. The reason is that the active material and the conductive agent are not uniformly combined due to dispersive and structural characteristics of fine-grain conductive agent.

In cases of general electrochemical capacitors, expression of electrons due to absorbing and desorbing reactions of electrolytic ions on a surface of the activated carbon leads to realization of capacitance.

Meanwhile, an electrode used in the EDLC generally includes an active material, a conductive agent for improving conductivity, a binder, and the like. As can be confirmed from a particle form obtained by a scanning electron microscope, of FIG. 2, particles of the active material become agglomerated in size of lop or more. Hence, the active material is difficult to pack and conductivity thereof is significantly degraded.

Therefore, the conductive agent is added to the active material in order to improve the conductivity. Here, particles of the conductive agent used herein are merely several tens of nanometers in size, as can be confirmed from a particle form obtained by a scanning electron microscope, of FIG. 3. In other words, since the active material and the conductive agent are largely different from each other in view of particle size, they may not be uniformly dispersed when an active material slurry for forming an electrode is prepared.

In the case of products particularly requesting high output characteristics among EDLC products, it is general to add a large amount of conductive agent so as to improve conductivity. However, in the case where an appropriate level or higher of conductive agent is added, capacitance characteristic may become rather reduced in spite of the same level of resistance characteristic.

The electrode is manufactured by \textcircled{1} a dry type mixing process of the above components, \textcircled{2} a granulating process, \textcircled{3} a kneading process, \textcircled{4} a preparing process of a slurry, and \textcircled{5} a coating process of the slurry to a current collector. However, since the active material and the conductive agent, which constitute the electrode, are different from each other by hundreds of times in view of particle sizes, the above processes cannot lead uniform dispersion of the particles.

In addition, the EDLC electrode generally consists of an active material 51, a conductive agent 52, a line-bonding type binder 53a, and a point-bonding type binder 53b. A dispersion type thereof within the electrode active material composition is shown in FIG. 4. In the electrode active material, the line-bonding type binder 53a contributes to bonding between particles of the active material and particles of the conductive agent, and the point-bonding type binder 53b contributes to bonding between the electrode active material and a current collector.

Even though general binders used in the electrode active material have different functions within the electrode active material depending on structures thereof, they are presently mixed and used in the electrode active material. As a result, when an artificial force from the outside is applied to an electrode having this composition, two kinds of representative defects may occur depending on combination of the binders, as shown in FIGS. 5 and 6.

In other words, FIG. 5 shows a defect type in which an interface between a current collector 10 and an electrode active material layer 20a is delaminated (A) since bonding strength between the current collector 10 and the electrode active material layer 20a is weakened.

Also, FIG. 6 shows a defect type in which a portion of an electrode active material layer 20a formed on a current collector 10 is delaminated (B). The electrode needs to be thickened in order to manufacture high-capacity products, and here, these types of defects may occur more seriously.

Therefore, a minimum amount of binder needs to be added within the electrode active material in order to realize physical bonding of the electrode and at least a predetermined amount of binder needs to be added in order to develop low-resistance products, and thus, by properly combining these facts, there is needed an electrode structure capable of increasing a capacitance of an electrochemical device.

### SUMMARY OF THE INVENTION

An object of the present invention is to provide an electrode for a low-resistance/high-capacitance electrochemical capacitor, capable of improving long-term reliability, by differentiating the kind of binder and the composition of binder depending on the position of the electrode active material layer.

Another object of the present invention is to provide a method for preparing the electrode.

Still another object of the present invention is to provide an electrochemical capacitor including the electrode.

According to an exemplary embodiment of the present invention, there is provided an electrode including a plurality of electrode active material layers formed above an electrode current collector, wherein each of the electrode active material layers includes different structures of binders.

The electrode active material layer contacted with the electrode current collector may contain 60 to 95 wt % of a point-bonding type binder based on the solid content of total binders therein; and each of the electrode active material layers contacted with each other may contain 10 to 20 wt % of a line-bonding type binder based on the solid content of total binders therein.

The point-bonding type binder may be at least one selected from the group consisting of styrene-butadiene rubber (SBR), butadiene rubber, acryl-based rubber, polyvinylpyrrolidone (PVP), isoprene rubber, and carboxylic methyl cellulose (CMC).

The line-bonding type binder may be at least one selected from the group consisting of polytetrafluoroethylene (PTFE), polyvinylidenefluoride (PVDF), and polyvinyl formamide (PVFA).

According to another exemplary embodiment of the present invention, there is provided a method for manufacturing an electrode, including: forming a first electrode active material layer by coating an electrode active material composition including a point-bonding type binder as a main component on an electrode current collector; and forming a second electrode active material layer by coating an electrode active material composition including a line-bonding type binder on the first electrode active material layer.

The point-bonding type binder included in the first electrode active material layer may be contained in 60 to 95 wt % based on the solid content of total binders therein.

The line-bonding type binder included in the second electrode active material layer may be contained in 10 to 20 wt % based on the solid content of total binders therein.

The method may further include forming a plurality of electrode active material layers above the second electrode active material layer.

The plurality of electrode active material layers formed above the second electrode active material layer may be formed by coating an electrode active material composition including 10 to 20 wt % of a line-bonding type binder based on the solid content of total binders therein.

According to still another exemplary embodiment of the present invention, there is provided an electrochemical capacitor including the electrode.

The electrode may be any one or both of a cathode and an anode.

### BRIEF DESCRIPTION OF THE DRAWINGS

FIG. 1 shows a basic structure and an operating principle of a general electric double layer capacitor;

FIG. 2 is a scanning electron microscope image of particles of an active material;

FIG. 3 is a scanning electron microscope image of particles of a conductive agent;

FIG. 4 shows a structure in which respective components are dispersed in an electrode active material composition;

FIGS. 5 and 6 show defect types occurring in an electrode according to the binder composition; and

FIG. 7 shows an electrode structure of an electric double layer capacitor according to an exemplary embodiment of the present invention.

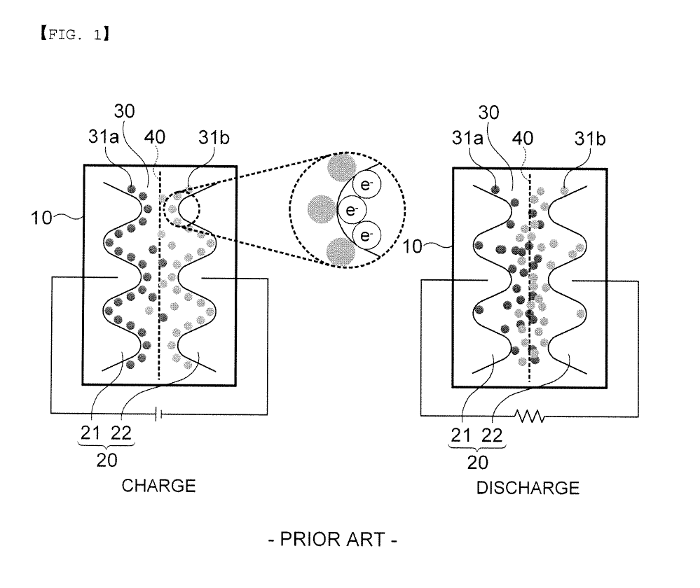

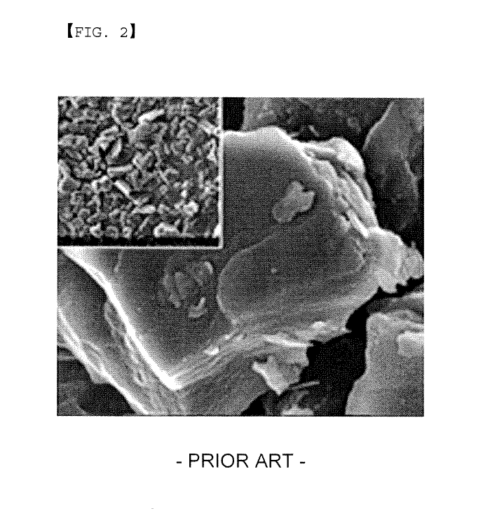

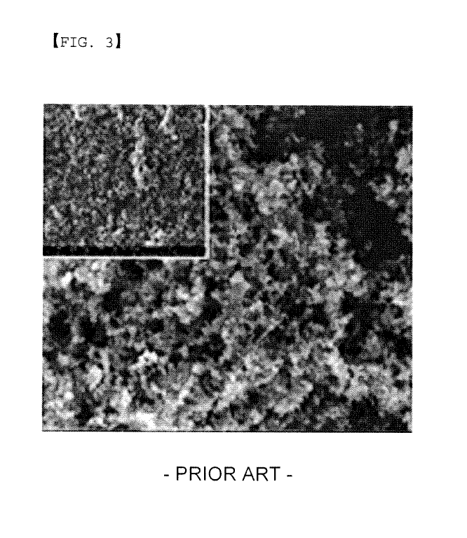

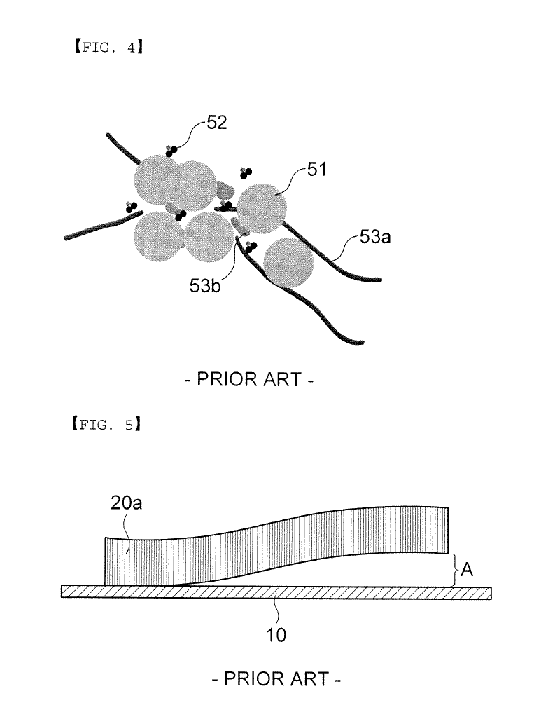

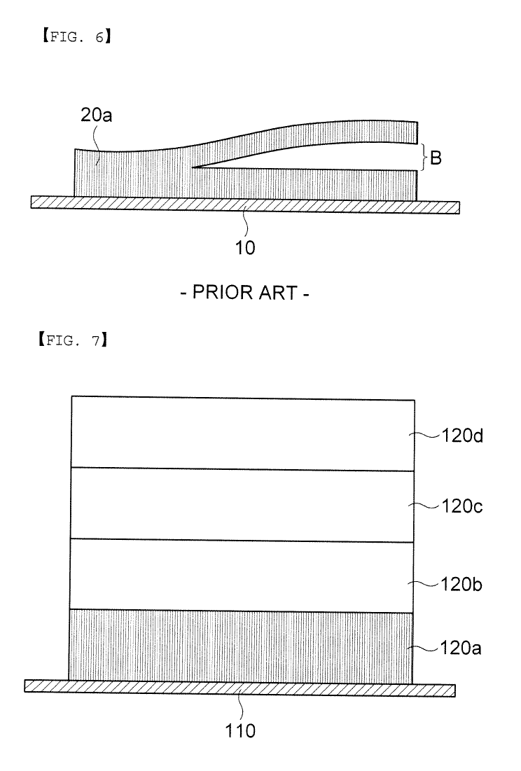

### DESCRIPTION OF THE PREFERRED EMBODIMENTS

Hereinafter, the present invention will be described in more detail.

Terms used in the present specification are for explaining the embodiments rather than limiting the present invention. As used herein, unless explicitly described to the contrary, a singular form includes a plural form in the present specification. Also, as used herein, the word “comprise” and/or “comprising” will be understood to imply the inclusion of stated constituents, steps, operations and/or elements but not the exclusion of any other constituents, steps, operations and/or elements.

The present invention relates to an electrode including an active material layer having different binder compositions, a method for preparing the same, and an electrochemical capacitor including the same.

FIG. 7 shows a structure of an electrode according to an exemplary embodiment of the present invention. The electrode is characterized by including a multilayer type of electrode active material layers 120a and 120b formed on an electrode current collector 110, and here, the respective electrode active material layers 120a and 120b may include different structures of binders.

According to one exemplary embodiment of the present invention, the electrode active material layer 120a contacted with the electrode current collector 110 preferably contains 60 to 95 wt % of a point-bonding type binder based on the solid content of total binders therein.

The different structures of binders, which are used throughout the specification of the present invention, mean a point-bonding type binder and a line-bonding type binder. Here, the ‘point-bonding type binder’ means that polymer chains constituting the binder are entangled with one another, and this binder serves to bond the electrode active material layer and the electrode current collector to each other.

Examples of the point-bonding type binder of the present invention may include at least one selected from styrene-butadiene rubber (SBR), butadiene rubber, acryl-based rubber, polyvinylpyrrolidone (PVP), isoprene rubber, and carboxylic methyl cellulose (CMC).

If the content of the point-bonding type binder within the electrode active material layer 120a contacted with the electrode current collector 110 is below 60 wt %, adhesion between the active material and the electrode current collector may be weakened. Alternatively, if above 95 wt %, the resistance thereof may increase due to a large amount of binder. Besides the above content, the line-bonding type binder below or other binder resins may be used, but the kinds thereof are not particularly limited.

In addition, as shown in FIG. 7, respective electrode active material layers 120b, 120c, and 120d contacted with each other are preferably designed to contain 10 to 20 wt % of a line-bonding type binder based on the solid content of total binders therein.

The ‘point-bonding type binder’ which are used throughout the specification of the present invention, means that polymer chains constituting the binder are lengthily connected to each other in a linear structure, and this binder serves to bond particles of an active material included in the electrode active material layer and particles of the conductive agent to each other.

Examples of the line-bonding type binder of the present invention may include at least one selected from polytetrafluoroethylene (PTFE), polyvinylidenefluoride (PVDF), and polyvinyl formamide (PVFA).

If the content of the line-bonding type binder within each of the electrode active material layers 120b, 120c, and 120d, which are contacted with each other, is below 10 wt %, adhesion between the active material and the electrode current collector may be weakened. Alternatively, if above 20 wt %, resistance may increase due to a large amount of binder. Besides the above content, the point-bonding type binder above or other binder resins may be used, but the kinds thereof are not particularly limited.

The present invention can improve the bonding strength between the electrode active material layer and the electrode current collector and solve the problems occurring within the electrode active material layer or between the electrode active material layers, by increasing the amount of binder polymers having a linear type structure in the electrode active material layer contacted with the electrode current collector and increasing the amount of binder polymers capable of mainly realizing point contact characteristics for bonding among the particles in the electrode active material layer, in consideration of different functions of binders in the electrode active material layer according to the structure of the binder.

According to one exemplary embodiment of the present invention, a method for manufacturing the electrode according to one exemplary embodiment of the present invention may be include: forming a first electrode active material layer by coating an electrode active material composition including a point-bonding type binder as a main component on the electrode current collector; and forming a second electrode active material layer by coating an electrode active material composition including a line-bonding type binder on the first electrode active material layer.

According to one exemplary embodiment of the present invention, the point-bonding type binder included in the first electrode active material layer may be contained in 60 to 95 wt % based on the solid content of total binders therein.

According to one exemplary embodiment of the present invention, the line-bonding type binder included in the second electrode active material layer may be contained in 10 to 20 wt % based on the solid content of total binders therein.

According to one exemplary embodiment of the present invention, the method may further include forming a plurality of electrode active material layers above the second electrode active material layer. The plurality of electrode active material layers formed above the second electrode active material layer may be formed by coating an electrode active material composition including a line-bonding type binder on the second electrode active material layer. In other words, the content of the line-bonding type binder is increased as a binder resin, in each of the electrode active material layers contacted with each other, and thus, bonding strength thereof is preferably improved.

The electrode according to the present invention may be manufactured by coating an electrode active material composition including an electrode active material, a conductive agent, and a solvent, besides the binder resin, on the electrode current collector.

Meanwhile, as the active material included in the electrode active material of the present invention, a carbon material having a particle size of 5 to 30 μm may be used. Specific examples of the carbon material may include at least one selected from the group consisting of activated carbon, carbon nanotube (CNT), graphite, carbon aero gel, polyacrylonitrile (PAN), carbon nanofibers (CNF), activated carbon nanofibers (ACNF), vapor-grown carbon fiber (VGCF), and graphene, but not limited thereto.

According to one embodiment of the present invention, an activated carbon having a specific surface area of 1,500 to 3,000 m²/g, among the active materials, may be preferably used.

As the conductive agent according to the present invention, at least one conductive carbon selected from the group consisting of Super-P, acetylene black, carbon black, and Ketjen black may be preferably used.

Any material that can be used in conventional electric double-layer capacitors or lithium ion batteries may be used for a cathode current collector. Examples of the material may be at least one selected from a group consisting of aluminum, stainless, titanium, tantalum, and niobium, and among them, aluminum is preferable.

Preferably, the cathode current collector may have a thickness of about 10 to 300 μm. An example of the electrode current collector may include a metal foil, an etched metal foil, or those having holes penetrating through front and rear surfaces thereof, such as an expanded metal, a punching metal, a net, a foam, or the like.

In addition, any material that can be used in conventional electric double-layer capacitors or lithium ion batteries may be used for an anode current collector. Examples of the material may be stainless, copper, nickel, or an alloy thereof, and among them, copper is preferable. In addition, the thickness thereof may be about 10 to 300 μm. An example of the electrode current collector may include a metal foil, an etched metal foil, or those having holes penetrating through front and rear surfaces thereof, such as an expanded metal, a punching metal, a net, foam, or the like.

In the present invention, a mixture of the electrode active material, the conductive agent, and the solvent may be molded in a sheet form by using the binder resin, or a molded sheet extruded by an extrusion method may be bonded to the electrode current collector by using a conductive adhesive.

The electrode according to the present invention may be used as any one or both of a cathode and an anode. In other words, the cathode in which the electrode active material composition prepared as above is coated on a cathode current collector and the anode in which the electrode active material composition prepared as above is coated on an anode current collector are insulated from each other by a separator, and this resulting structure is impregnated with an electrolytic liquid, followed by sealing, thereby manufacturing a final electrochemical capacitor.

As the separator according to the present invention, any material used in the electric double-layer capacitor or lithium ion battery of the related art may be used, and, an example thereof may be a microporous film prepared from at least one polymer selected from the group consisting of polyethylene (PE), polypropylene (PP), polyvinylidene fluoride (PVdF), polyvinlylidene chloride, polyacrylonitrile (PNA), polyacrylamide (PAAm), polytetrafluoro ethylene (PTFE), polysulfone, polyethersulfone (PES), polycarbonate (PC), polyamide (PA), polyimide (PI), polyethylene oxide (PEO), polypropylene oxide (PPO), cellulose based polymer, and polyacryl based polymer. Also, a multilayer film obtained by polymerizing the microporous film may be used as the separator, and the cellulose based polymer may be preferably used among these.

Preferably, the separator has a thickness of 15 to 35 μm, but is not limited thereto.

As the electrolytic liquid of the present invention, an organic electrolytic liquid including a non-lithium salt, such as a spiro based salt, TEABF4, TEMABF 4, or the like, or a lithium salt, such as LiPF₆, LiBF₄, LiCLO₄, LiN(CF₃SO₂)₂, CF₃SO₃Li, LiC(SO₂CF₃)₃, LiAsF₆, LiSbF₆, or the like, or a mixture thereof may be used. Examples of the solvent may include at least one selected from the group consisting of an acrylonitrile based solvent, ethylene carbonate, propylene carbonate, dimethyl carbonate, ethylmethyl carbonate, sulforane, and dimethoxyethane, but are not limited thereto. The electrolytic liquids obtained by combining these solutes and solvents have high withstand voltage and high electric conductivity. The concentration of electrolyte in the electrolytic liquid is preferably 0.1 to 2.5 mol/L, 0.5˜2 mol/L.

A laminate film including aluminum, which is commonly used in a secondary battery and an electrical double layer capacitor, is preferably used as a case (an exterior part) of the electrochemical capacitor of the present invention, but particularly not limited thereto.

Hereinafter, examples of the present invention will be described in detail. The following examples are only for illustrating the present invention, and the scope of the present invention should not be construed as being limited by this examples. In addition, specific compounds are used in the following examples, but it is obvious to those skilled in the art that equivalents thereof can exhibit the same or similar degrees of effects.

### Example 1

A first active material slurry composition was prepared by mixing 85 g of activated carbon (specific surface area 2550 m²/g), 18 g of a conductive agent Super-P, and binder composition of Table 1 below, with 225 g of water, followed by stirring.

A second active material slurry composition was prepared by mixing 85 g of activated carbon (specific surface area 2550M²/g), 18 g of a conductive agent Super-P, and binder composition of Table 1 below, with 225 g of water, followed by stirring.

The first active material slurry composition was coated on a 20 μm-thick aluminum etching foil to have a thickness of 10 μm by using a comma coater, followed by drying, thereby forming a first electrode active material layer.

The second active material slurry composition was coated on the first electrode active material layer to have a thickness of 60 μm by using a comma coater, followed by drying, thereby forming a second electrode active material layer.

As necessary, an additive electrode active material layer may be formed by using the second active material slurry composition. The thus manufactured electrode was cut to an electrode size of 50 mm×100 mm. The finally manufactured electrode had a cross-sectional thickness of 63 μm. The electrode was dried under vacuum at 120° C. for 48 hours, before a cell is assembled.

A separator (TF4035 from NKK, cellulose-based separator) was inserted between a cathode and an anode formed by using the thus manufactured electrode, and then the resulting structure was impregnated with an electrolytic liquid (within an acrylonitrile-based solvent, spyro-based salt concentration: 1.3 mole/L), which was then put and sealed in a laminated film case. The completed cell was left intact for one day before experimental measurement.

TABLE 1

| | | Binder | |
|---|---|---|---|
| | | First active material | Second active material |
| Content: g | | slurry composition | slurry composition |
| Point-bonding | CMC | 10.0 | 28.0 |
| type binder | PVP | 4.5 | 0 |
| | SBR | 17.0 | 14.5 |
| Line-bonding | PTFE | 3.0 | 10.5 |
| type binder | | | |

In the first active material slurry composition, the point-bonding type binder was contained in 91 wt % based on the solid content of total binders therein. Also, in the second active material slurry composition, the line-bonding type binder, PTFE, was contained in 19.8 wt % based on the solid content of total binders therein.

### Comparative Example 1

An active material slurry composition was prepared by mixing 85 g of activated carbon (specific surface area 25501117 g), 18 g of a conductive agent Super-P, and, as binder, 3.5 g of CMC, 12.0 g of SBR, and 5.5 g of PTFE, with 225 g of water, followed by stirring.

The active material slurry composition was coated on an etched aluminum foil with a thickness of 20 μm by using a comma coater, followed by temporary drying, and then the resulting material was cut into 50 mm×100 mm sized electrodes. The electrode had a cross-sectional thickness of 60 μm. The electrode was dried under vacuum at 120° C. for 48 hours, before a cell is assembled.

A separator (TF4035 from NKK, cellulose-based separator) was inserted between a cathode and an anode formed by using the thus manufactured electrode, and then the resulting structure was impregnated with an electrolytic liquid (within a acrylonitrile-based solvent, spyro-based salt concentration: 1.3 mole/L), which was then put and sealed in a laminated film case. The thus completed cell was left intact for one day before the experimental measurement.

### Experimental Example 1

### Measurement of Bonding Strength in Manufactured Electrode

Bonding strength of each of the electrodes manufactured according to a comparative example and an example was measured by using a peel strength gauge, and then the results thereof were tabulated in Table 2 below.

TABLE 2

| | Bonding strength (N/m) |
|---|---|
| Example | 9.3 |
| Comparative example | 4.2 |

As shown in Table 2 above, it was confirmed that the bonding strength of the electrochemical capacitor having the electrodes according to the present invention was twice or more the bonding strength of the electrochemical capacitor having the electrodes of the related art.

Therefore, it can be seen that the present invention effectively improved the bonding strength between the electrode current collector and the electrode active material layer and the bonding strength between the electrode active material layers, by forming a multilayer type of electrodes active material layers having different structures of binders.

### Experimental Example 2

### Measurement of Resistance and Capacitance in Electrochemical Capacitor Cell

When each of the electrochemical capacitor cells manufactured according to the comparative example and the example was charged to 2.8V with a constant current and discharged to 2.0V with the same current at the time of charging for each cycle, a discharging capacitance at the time of a fifth cycle was measured, and an initial resistance was measured by using an AC meter.

TABLE 3

| | Initial capacitance | Alternating current |
|---|---|---|
| | (F) | resistance (mW) |
| Example | 16.1 | 9.8 |
| Comparative | 16.3 | 13.1 |
| example | | |

As shown in Table 3, bonding property between active materials and bonding property between an active material electrode and an Al electrode current collector improved due to optimal combination of the binders, resulting in improved resistance characteristics.

In addition, 10,000 charging and discharging cycles were performed on each of the electrochemical capacitor cells manufactured according to the comparative example and the example at the conditions of 100 C rate, and then electric properties thereof were measured. The results were tabulated in Table 4 below.

TABLE 4

| | | Alternating current resistance |
|---|---|---|
| | Capacitance (F) | (mW) |
| Example | 15.3 (95%) | 11.8 (120%) |
| Comparative example | 13.7 (84%) | 22.3 (170%) |

As shown in Table 4, it was confirmed that, in the case of the example, bonding property was improved, and thus, the capacitance retention ratio and the resistance characteristics were improved.

According to the present invention, physical bonding strength of the electrode can be significantly improved, and thus, long-term reliability of the electrochemical capacitor can be improved, by developing an electrode in which the binder composition of a bonding portion of an electrode and an electrode current collector and the binder composition between the electrode active material layers are differentiated from one another, in order to develop low-resistance EDLC products.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An electrode comprising a plurality of electrode active material layers formed above an electrode current collector, wherein each of the electrode active material layers includes different structures of binders.

2. The electrode according to claim 1, wherein the electrode active material layer contacted with the electrode current collector contains 60 to 95 wt % of a point-bonding type binder based on the solid content of total binders therein; and each of the electrode active material layers contacted with each other contains 10 to 20 wt % of a line-bonding type binder based on the solid content of total binders therein.

3. The electrode according to claim 2, wherein the point-bonding type binder is at least one selected from the group consisting of styrene-butadiene rubber (SBR), butadiene rubber, acryl-based rubber, polyvinylpyrrolidone (PVP), isoprene rubber, and carboxylic methyl cellulose (CMC).

4. The electrode according to claim 2, wherein the line-bonding type binder is at least one selected from the group consisting of polytetrafluoroethylene (PTFE), polyvinylidenefluoride (PVDF), and polyvinyl formamide (PVFA).

5. A method for manufacturing an electrode, comprising:
forming a first electrode active material layer by coating an electrode active material composition including a point-bonding type binder as a main component on an electrode current collector; and
forming a second electrode active material layer by coating an electrode active material composition including a line-bonding type binder on the first electrode active material layer.

6. The method according to claim 5, wherein the point-bonding type binder included in the first electrode active material layer is contained in 60 to 95 wt % based on the solid content of total binders therein.

7. The method according to claim 5, wherein the line-bonding type binder included in the second electrode active material layer is contained in 10 to 20 wt % based on the solid content of total binders therein.

8. The method according to claim 5, further comprising forming a plurality of electrode active material layers above the second electrode active material layer.

9. The method according to claim 8, wherein the plurality of electrode active material layers formed above the second electrode active material layer are formed by coating an electrode active material composition including 10 to 20 wt % of a line-bonding type binder based on the solid content of total binders therein.

10. An electrochemical capacitor comprising the electrode according to claim 1.

11. The electrochemical capacitor according to claim 10, wherein the electrode is any one or both of a cathode and an anode.
